(19) United States
(12) Patent Application Publication
(10) Pub. No.: US 2013/0141825 A1
(43) Pub. Date: Jun. 6, 2013

(54) ESD PROTECTION CIRCUIT

(71) Applicants: Nobutaka KITAGAWA, Tokyo (JP); Takuma AOYAMA, Kanagawa-ken (JP); Yoshitaka SAMPEI, Kanagawa-ken (JP)

(72) Inventors: Nobutaka KITAGAWA, Tokyo (JP); Takuma AOYAMA, Kanagawa-ken (JP); Yoshitaka SAMPEI, Kanagawa-ken (JP)

(73) Assignee: KABUSHIKI KAISHA TOSHIBA, Tokyo (JP)

(21) Appl. No.: 13/607,492

(22) Filed: Sep. 7, 2012

(30) Foreign Application Priority Data
Dec. 2, 2011 (JP) P2011-264507

(51) Int. Cl. H02H 9/04

(52) U.S. Cl. 361/56

(57) ABSTRACT

An electrostatic discharge (ESD) protection circuit includes first and second transistors connected in series between first and second power supply nodes. A third transistor of the ESD protection circuit turns the second transistor to OFF during normal operation. A fourth transistor of the ESD protection circuit turns the first transistor ON during ESD operation. During normal operation, a damping time constant circuit of the ESD protection circuit turns the fourth transistor OFF, and during ESD operation, turns the fourth transistor ON. A fifth transistor of the ESD protection circuit turns the second transistor ON during ESD operation. The first to fifth transistors each have a voltage resistance level that is lower than power supply voltage.

### CROSS-REFERENCE TO RELATED APPLICATION

This application is based upon and claims the benefit of priority from Japanese Patent Application No. 2011-264507, filed Dec. 2, 2011; the entire contents of which are incorporated herein by reference.

### FIELD

Embodiments described herein relate to a semiconductor device, for example, an ESD protection circuit, which can protect a power supply circuit from electrostatic discharge (Electro Static Discharge) (hereafter referred to as ESD).

### BACKGROUND

A power supply voltage supplied to a semiconductor device varies and can be 3.3V/2.5V/1.8V. As a result, a thick film transistor (called thick film) which operates with 3.3V/2.5V, an inside film transistor which operates with 1.8V, and a thin film transistor (called a thin film transistor) which operates with 0.9V to 1.2V, are used. For miniaturization, e.g., for semiconductor devices having 65 nm features sizes, it is not favorable to use three types of transistors because they increase the cost of manufacturing.

Instead, a tolerant type circuit that operates with voltages not more than 1.8V, but can bear the power supply voltage of 3.3V/2.5V has been developed without incorporating a transistor which operates with 3.3V/2.5V. Such tolerant type circuit needs to similarly include an ESD protection circuit that is used for ESD protection of a power supply.

### DESCRIPTION OF THE DRAWINGS

FIG. 1 is a circuit diagram showing an ESD protection circuit according to an embodiment.

FIGS. 2A, 2B, 2C, and 2D are circuit diagrams showing different operating states of the ESD protection circuit of FIG. 1.

FIG. 3 is a circuit diagram that shows a first modification of the embodiment.

FIG. 4 is a circuit diagram that shows a further modification of the modified embodiment.

FIG. 5 is a circuit diagram that shows a second modification of the embodiment.

### DETAILED DESCRIPTION

In general, one embodiment will be explained with reference to the figures.

In one embodiment, a transistor that provides voltage resistance up to a level that is lower than the power supply voltage is implemented in an ESD protection circuit for a power supply circuit, so as to reduce the number of circuit elements in the ESD circuit.

The ESD protection circuit according to the embodiment includes a first power supply node to which a first power supply voltage is supplied, first and the second transistors of a first conduction type that are connected in series between the first power supply node and a second power supply node to which a second power supply voltage lower than the first power supply voltage is supplied, a third transistor of the first conduction type, and fourth and fifth transistors of a second conduction type. The voltage resistance levels of the transistors are each lower than the first power supply voltage.

One end of a current path through the third transistor is connected to a gate of the second transistor, and the other end of the current path is connected to the second power supply node. During normal operation, a third voltage higher than the second power supply voltage is supplied to a gate of the third transistor.

One end of a current path through the fourth transistor is connected to the first power supply node, and the other end of the current path is connected to a gate of the first transistor. During ESD operation, the fourth transistor causes the first transistor to be in an ON state. During normal operation, the fourth transistor is in an OFF state.

During ESD operation, one end of a damping time constant circuit of the ESD protection circuit causes the fifth transistor to be in an ON state, so that a current path is established between one end to the other end of the fifth transistor which is connected to the gate of the second transistor. The fifth transistor has a third voltage supplied to its gate, changes into an OFF state during normal operation, and causes the second transistor to change into an ON state during ESD operation. The fifth transistor is connected between the other end of the current path of the fourth transistor and the gate of the first transistor, and provides a resistance which supplies a bias voltage to the gate of the first transistor during normal operation.

### Embodiment

The semiconductor device of this embodiment is an ESD protection circuit configured with a transistor that operates with voltages not more than 1.8V but is supplied with a power supply voltage that is beyond the voltage resistance level of the transistor, for example, 3.3V, and protects the power supply of this circuit from ESD.

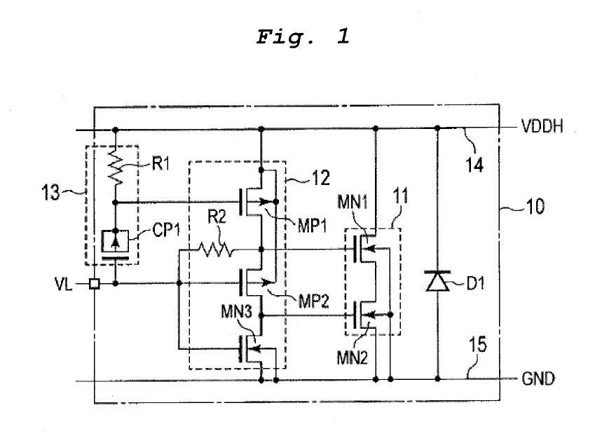

An ESD protection circuit 10 that is shown in FIG. 1 includes an ESD clamp circuit 11, a gate bias circuit 12, a damping time constant circuit 13, and a diode D1.

The ESD clamp circuit 11 includes two n channel MOS transistor (hereafter called NMOS transistor) MN1 and MN2. The NMOS transistors MN1 and MN2 is connected in series between a power supply line 14 to which a power supply voltage VDDH is applied and a ground line 15 which is at the ground potential GND. The substrate of the NMOS transistors MN1 and MN2 is also connected to the ground line 15.

The gate bias circuit 12 includes two p channel MOS transistors (hereafter called PMOS transistor) MP1 and MP2, an NMOS transistor MN3, and a resistor R2. The PMOS transistors MP1, MP2, and the NMOS transistor MN3 are connected in series between the power supply line 14 and the ground line 15. In addition, the substrate of the NMOS transistor MN3 is connected to the ground line 15, and the substrate of PMOS transistors MP1 and MP2 is connected to the power supply line 14.

A connection node between the PMOS transistors MP1 and MP2 is connected to the gate of the NMOS transistor MN1, and a connection node between the PMOS transistor MP2 and the NMOS transistor MN3 is connected to the gate of the NMOS transistor NM2. Moreover, the gates of the PMOS transistor MP2 and the NMOS transistor MN3 are each connected to the power supply terminal VL. A mid-level voltage VDDL, for example, 1.8V, is applied to the power supply terminal VL from an external source at the time of normal operation of the semiconductor device. The mid-level voltage VDDL is not limited to 1.8V, and can be any voltage that is higher than the ground potential, is lower than the power supply voltage VDDH, and can turn ON the NMOS transistor MN3. The resistor R2 is connected between the power supply terminal VL and the connection node between the PMOS transistors MP1 and MP2.

Continuing, the damping time constant circuit 13 includes a resistor R1 and capacitor CP1 that includes a PMOS transistor, in one embodiment. The resistor R1 and the capacitor CP1 are connected in series between the power supply line 14 and the power supply terminal VL. The connection node between the resistor R1 and capacitor CP1 is connected to the gate of the PMOS transistor MP1. In addition, the cathode of the diode D1 is connected to the power supply line 14, and the anode is connected to the ground line 15.

The voltage resistance level of the NMOS transistors MN1, MN2, MN3, and the PMOS transistors MP1, MP2 is set as 1.8V, and 3.3V is applied to the power supply line 14 as the power supply voltage VDDH at the time of the normal operation of the semiconductor device.

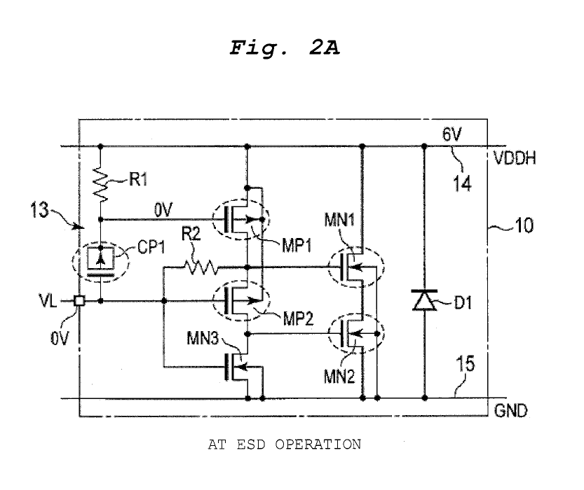

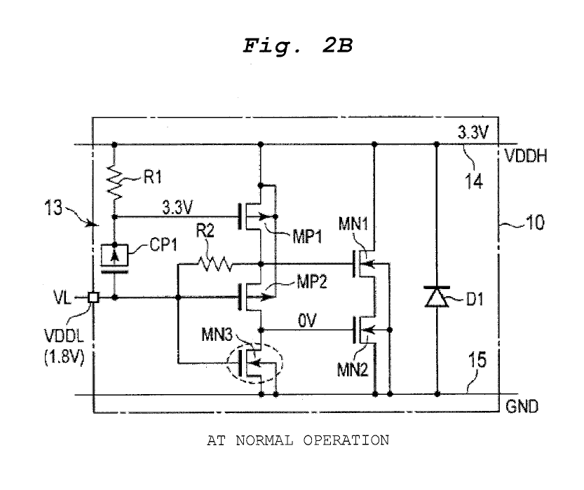

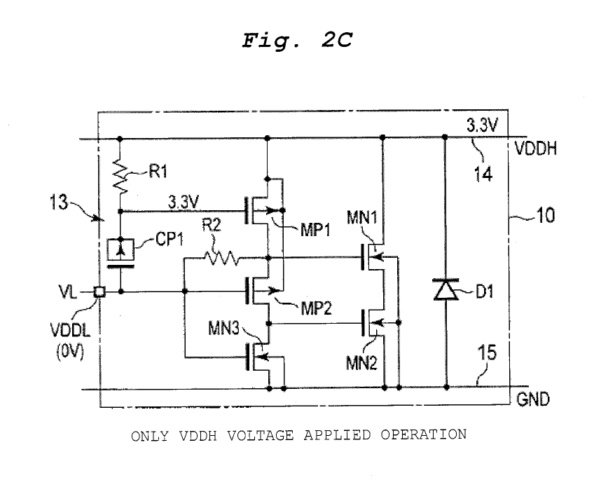

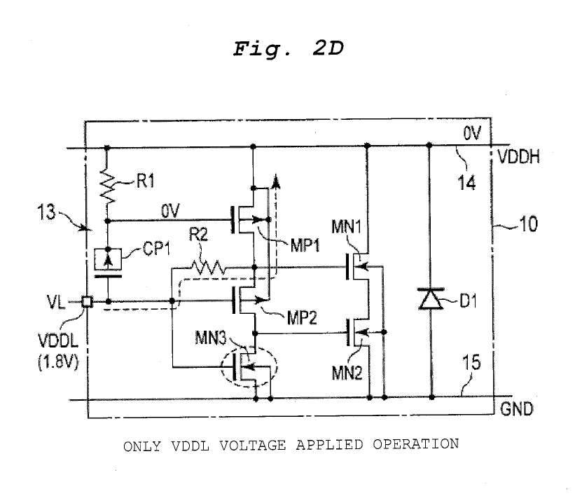

The operation of the semiconductor device is explained with reference to FIGS. 2A, 2B, 2C, and 2D. In FIGS. 2A, 2B, 2C, and 2D, the dashed line round marks show the marked transistor in ON state.

### [During ESD Operation]

Next, the operation during ESD is explained.

Prior to the occurrence of ESD, which is shown in FIG. 2A, the state of all the transistors, when the power supply is not supplied to the semiconductor device, are in the OFF state. When ESD occurs and 6V is applied to the power supply line 14, the voltage of the power supply line 14 is applied to the gate of each of the NMOS transistors MN1, MN2, which are part of the clamp circuit 11, because the PMOS transistors MP1, MP2 are in the ON state. For this reason, the NMOS transistor MN1 and MN2 are switched ON, and the ESD current is discharged from the power supply line 14 to the ground line 15 through the NMOS transistor MN1 and MN2. Accordingly, a power supply circuit is protected from ESD. FIG. 2A shows the state of the semiconductor device during such ESD operation.

Moreover, in the state where the power supply line 14 and the power supply terminal VL are 0V, when ESD occurs such that a negative voltage is applied to the power supply line 14, the diode D1 is then set to ON. As a result, the ESD current is discharged to the power supply line 14 through the diode D1, and the power supply circuit is protected from ESD.

### [During Normal Operation]

On the other hand, as shown in FIG. 2B, at the time of the normal operation of the semiconductor device, the power supply voltage VDDH, for example, 3.3V, is applied to the power supply line 14, and the ground line 15 is grounded. Furthermore, the middle voltage VDDL, for example, 1.8V, is supplied to the power supply terminal VL from the exterior. As a result, the NMOS transistor MN3 by which the gate is connected to the power supply terminal VL is in an ON state, and the PMOS transistor MP2 is in an OFF state. The NMOS transistor MN2 is in an OFF state, and the NMOS transistor MN1, the gate of which is connected to the power supply terminal VL through the resistor R2, is in the ON state slightly. Moreover, the capacitor CP1 is charged by 3.3V and the PMOS transistor MP1, the gate of which is connected to the connection node between the resistor R1 and capacitor CP1, which constitute the damping time constant circuit 13, is changed to the OFF state.

When the threshold voltage of the NMOS transistor MN1 is set to 0.3V and the voltage drop of resistor R2 is disregarded, the voltage Vgs between the gate and the source of the NMOS transistor MN1 is 1.5V (=1.8V−0.3V). Therefore, the voltage Vds between the drain and the source of the NMOS transistor MN1 is 1.8V (=3.3V−1.5V). Accordingly, the voltage of each part of the NMOS transistor MN1 lies within its voltage resistance level.

Moreover, since the voltage Vgs between the gate and the source of the NMOS transistor MN2 is 0V and the voltage at the drain of the NMOS transistor MN2 is 1.5V, the voltage Vds between the drain and the source of the NMOS transistor MN2 in an ON state is 1.5V−0V=1.5 V. Accordingly, the voltage of each part of the NMOS transistor MN2 also lies within its voltage resistance level.

The voltage Vds between the drain and the source of the PMOS transistor MP1 is 3.3V−1.8V=1.5V, and the voltage Vgs between the gate and the source of the PMOS transistor MP1 lies within its voltage resistance level.

The voltage Vds between the drain and the source of the PMOS transistor MP2 is 1.8V−0V=1.8V, and the voltage Vgs between the gate and the source of the PMOS transistor MP2 lies within its voltage resistance level.

Moreover, the voltage Vgs between the gate and the source of the NMOS transistor MN3 is 1.8V−0V=1.8V, and the voltage between the drain and the source of the NMOS transistor MN3 is 0V. Accordingly, the voltage of each part of the NMOS transistor MN3 also lies within its voltage resistance level.

Thus, the ESD protection circuit 10 of this embodiment meets the performance tolerance at the time of the normal operation of the semiconductor device.

In addition, FIG. 2C shows the case where the power supply voltage VDDH, for example, 3.3V, is applied to the power supply line 14, and the middle voltage VDDL is not applied to the external terminal VL. In this case, at the time of the normal operation shown in FIG. 2B, the NMOS transistor MN3 will be in an OFF state. Except for this, the ESD protection circuit 10 operates in the same manner as during normal operation.

FIG. 2D shows the case where the power supply voltage VDDH is not applied to the power supply line 14, but the middle voltage VDDL, for example, 1.8V, is applied to the external terminal VL. In this case, at the time of the ESD operation shown in FIG. 2A, the NMOS transistor MN3 will be in an ON state. Except for this, the ESD protection circuit 10 operates in the same manner as during ESD operation. In this case, since the voltage of the gate of the PMOS transistor MP1 is 0V, a leakage current flows to the power supply line 14 from the power supply terminal VL through the resistor R2, the PMOS transistor MP1, and a parasitic diode (not shown), the leakage current is reduced to a satisfactory level by the resistor R2.

According to the embodiment, a power supply may not be supplied to the semiconductor device during a non-operating state. In this state, gates of the PMOS transistors MP1, MP2 are connected to the damping time constant circuit 13 and the power supply terminal VL, respectively, and the PMOS transistor MP1 set in the ON state. The ground line 15 is made to discharge the ESD current from the power supply line 14 by making the NMOS transistors MN1 and MN2 turn on through the PMOS transistors MP1 and MP2 at the time of ESD generation. Accordingly, it is possible to protect a power supply circuit from ESD.

In addition, the voltage of each part of the NMOS transistor MN1, MN2, MN3, and the PMOS transistor MP1 and MP2 is set as 1.8V or less, i.e., less than the voltage resistance levels of these transistors at the time of normal operation. For this reason, it is possible to provide a tolerant type ESD protection circuit using transistors having low voltage resistance levels. Furthermore, since the number of elements in the circuit has been reduced, it is possible to minimize the overall circuit size.

### (First Modification)

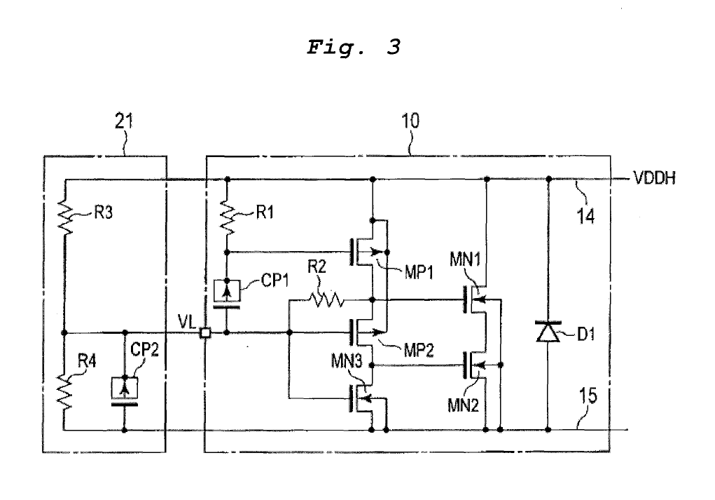

FIG. 3 shows a first modification of the embodiment, and uses the same references to identify elements that are common between FIG. 1 and FIG. 3. According to the embodiment, the middle voltage VDDL is supplied from outside the semiconductor device through the power supply terminal VL. By contrast, according to the first modification, the middle voltage VDDL is generated inside of the semiconductor device.

As shown in FIG. 3, the middle voltage generation circuit 21 is formed between the power supply line 14 and the ground line 15. The middle voltage generation circuit 21 includes a capacitor CP2, and resistors R3 and R4 connected in series between the power supply line 14 and the ground line 15. A PMOS transistor of the capacitor CP2 is connected to the resistor R4 in parallel. The middle voltage VDDL is outputted from the connection node between the resistor R3 and R4. This middle voltage VDDL is supplied to the power supply terminal VL.

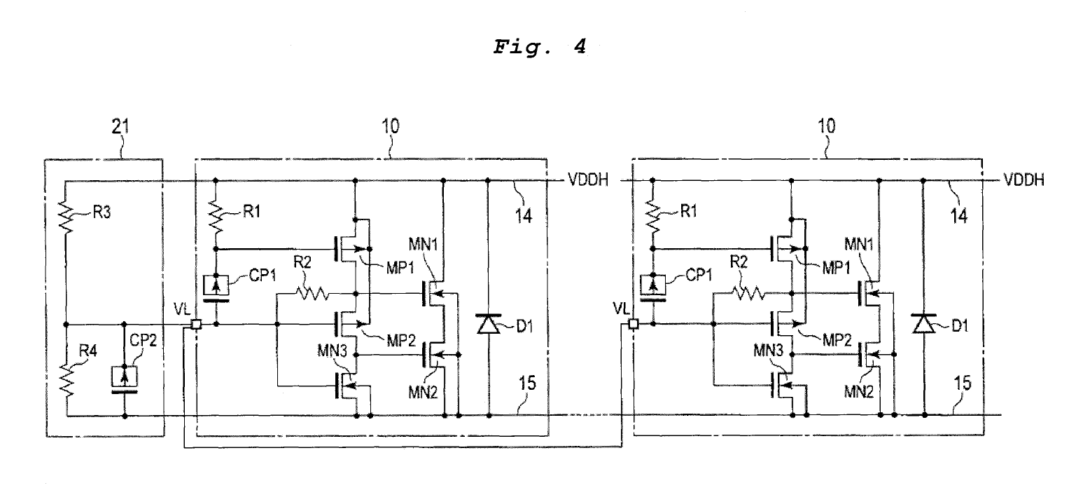

In addition, the power supply terminal VL becomes unnecessary, although the power supply terminal VL is indicated as a power supply node in FIG. 3. Moreover, the middle voltage generation circuit 21 is not limited to this configuration, where it is shown as connected to a single ESD protection circuit 10. For example, one middle voltage generation circuit 21 may be connected to multiple ESD(s) protection circuits 10, when two or more ESD protection circuits 10 are formed in the semiconductor device, as shown in FIG. 4.

According to the first modification, it is not necessary to apply the middle voltage from outside the semiconductor device. For this reason, it is possible to simplify the power supply specification of the semiconductor device.

### (Second Modification)

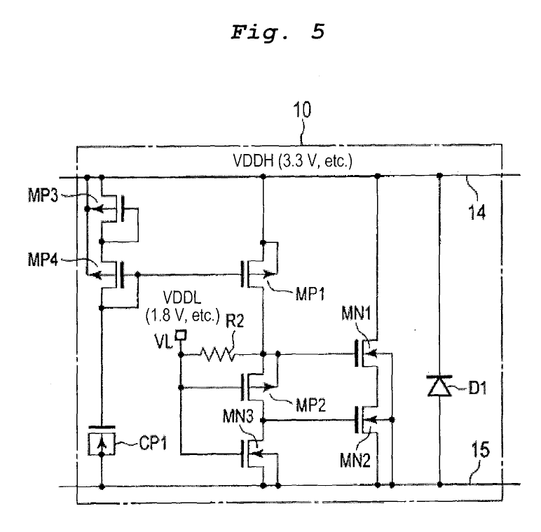

FIG. 5 shows a second modification of the embodiment. According to the embodiment, the damping time constant circuit 13 includes the resistor R1. By contrast, as shown in FIG. 5, the resistor R1 is replaced in the second modification with diode-connected PMOS transistors MP3 and MP4 that are connected in series and provide resistance.

More specifically, in the second modification, the damping time constant circuit 13 includes the PMOS transistors MP3 and MP4, which are connected in series between the power supply line 14 and the ground line 15, and the capacitor CP1. The capacitor CP1 is an NMOS transistor in the second modification. The drain of the PMOS transistor MP4 is connected with this capacitor CP1 and the gate of the PMOS transistor MP4 at a connection node between the gate of the PMOS transistor MP4 and the gate of the PMOS transistor MP1.

The second modification can also constitute the same damping time constant circuit as the embodiment, and the PMOS transistors MP3 and MP4 will provide resistance according to the second modification instead of the resistor R1. Compared with the case where resistance is formed in the same poly-silicon layer as a gate as in the embodiment, it is possible to reduce the circuit area, and thus to further miniaturize the circuit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrostatic discharge (ESD) protection circuit comprising:
first and second transistors of a first conduction type that are connected in series between a first power supply node to which a first power supply voltage is to be supplied, and a second power supply node to which a second power supply voltage lower than the first power supply voltage is to be supplied, the voltage resistance levels of the first and second transistors being lower than the first power supply voltage;
a third transistor of the first conduction type, one end of a current path through which is connected to a gate of the second transistor, the other end of the current path through which is connected to the second power supply node, the third transistor having a gate which is supplied with a third voltage that is less than the first voltage and greater than the second voltage during normal operation, the third transistor having a voltage resistance level that is lower than the first power supply;
a fourth transistor of a second conduction type, one end of a current path through which is connected to the first power supply node and the other end of the current path through which is connected to a gate of the first transistor, having a voltage resistance level that is lower than the first power supply voltage, and configured to cause the first transistor to be in an ON state during ESD operation;
a damping time constant circuit that is connected to the first power supply node, and configured to cause the fourth transistor to be in an OFF state during normal operation and in an ON state during ESD operation;
a fifth transistor of the second conduction type, one end of a current path through which is connected to the other end of the fourth transistor current path, the other end of the current path through which is connected to the gate of the second transistor, the fifth transistor being supplied with the third voltage so as to be in an OFF state during normal operation, and causing the second transistor to be in an ON state during ESD operation; and
a resistor that is connected between a supply node of the third voltage and the gate of the first transistor, and configured to supply a bias voltage to the gate of the first transistor during normal operation.

2. The ESD protection circuit according to claim 1, further comprising:
a voltage generation circuit for generating the third voltage from the first power supply voltage.

3. The ESD protection circuit according to claim 1,
wherein the damping time constant circuit comprises:
at least one sixth transistor of the second conduction type having its gate connected to its drain; and
a capacitor connected to the drain of the sixth transistor.

4. The ESD protection circuit according to claim 1, further comprising:
a diode that is connected between the first power supply node, and the second power supply node.

5. The ESD protection circuit according to claim 4, wherein an electric current flows from the second power supply node to the first power supply node through the diode when a negative voltage is applied to the first power supply node.

6. An electrostatic discharge (ESD) protection circuit comprising:
first and second transistors of a first conduction type that are connected in series between a first power supply node to which a first voltage is to be supplied and a second power supply node to which a second voltage that is lower than the first voltage is to be supplied;
a third transistor of the first conduction type that is connected between a gate of the second transistor and the second power supply node, having a gate that is to be supplied with a third voltage that is lower than the first voltage and higher than the second voltage as a result of which the second transistor is to be in an OFF state;
a fourth transistor of a second conduction type that is connected between the first power supply node and a gate of the first transistor, and configured to cause the first transistor to be in an ON state during ESD operation;
a damping time constant circuit that is connected to the first power supply node and a gate of the fourth transistor and is configured to cause the fourth transistor to be in an OFF state during normal operation, and in an ON state during ESD operation;
a fifth transistor of the second conduction type that is connected between the fourth transistor and the gate of the second transistor, having a gate that is supplied with the third voltage to cause the fifth transistor to be in an OFF state during normal operation and to cause the second transistor to be in an ON state during ESD operation,
wherein a voltage resistance level of each of the first through fifth transistors is lower than the first voltage.

7. The ESD protection circuit according to claim 6, further comprising:
a voltage generation circuit for generating the third voltage from the first voltage.

8. The ESD protection circuit according to claim 7,
wherein the damping time constant circuit comprises:
at least one sixth transistor of the second conduction type having its gate connected to its drain; and
a capacitor connected to the drain of the sixth transistor.

9. The ESD protection circuit according to claim 6, further comprising:
a diode that is connected between the first power supply node and the second power supply node.

10. The ESD protection circuit according to claim 9, wherein an electric current flows from the second power supply node to the first power supply node through the diode when a negative voltage is applied to the first power supply node.

11. An electrostatic discharge (ESD) protection circuit comprising:
first and second transistors of a first conduction type that are connected in series between first and second nodes each to be connected to a voltage source;
a third transistor of the first conduction type having a first end connected to a gate of the second transistor, a second end connected to the second node, and a gate connected to a third node to be connected to a voltage source;
a fourth transistor of a second conduction type having a first end connected to the first node and a second end connected to a gate of the first transistor;
a damping time constant circuit that is connected between the first node and a third node for to be connected to a voltage source, and configured to control ON/OFF state of the fourth transistor;
a fifth transistor of the second conduction type having a first end connected to the second end of the fourth transistor, a second end connected to the gate of the second transistor, and a gate connected to the third node; and
a resistor that is connected between the third node and a gate of the first transistor.

12. The ESD protection circuit according to claim 11, wherein the first node is connected to a first voltage, the second node is connected to a second voltage, and the third node is connected to a second voltage that is less than the first voltage but greater than the second voltage, and a voltage resistance level of each of the first through fifth transistors is lower than the first voltage.

13. The ESD protection circuit according to claim 12, wherein the second voltage is ground.

14. The ESD protection circuit according to claim 11, further comprising:
a diode that is connected between the first node and the second node.

15. The ESD protection circuit according to claim 11, wherein an electric current flows from the second node to the first node through the diode when a negative voltage is applied to the first node.

16. The ESD protection circuit according to claim 11, wherein an electric current flows from the first node to the second node through the first and second transistors during ESD operation.

17. The ESD protection circuit according to claim 11, further comprising:
a voltage generation circuit for generating the third voltage from the first voltage.

18. The ESD protection circuit according to claim 17,
wherein the damping time constant circuit comprises:
at least one sixth transistor of the second conduction type having its gate connected to its drain; and
a capacitor connected to the sixth transistor.

19. The ESD protection circuit according to claim 18, further comprising:
a diode that is connected between the first node, and the second node.

20. The ESD protection circuit according to claim 19, wherein an electric current flows from the second node to the first node through the diode when a negative voltage is applied to the first node.
